(19) United States
(12) Patent Application Publication
(10) Pub. No.: US 2024/0060008 A1
(43) Pub. Date: Feb. 22, 2024

(54) COMPOSITION

(71) Applicant: CONOPCO, INC., D/B/A UNILEVER, Englewood Cliffs, NJ (US)

(72) Inventors: Sarmistha Biswas, Bangalore (IN); Rachana Sankar, Bangalore (IN)

(73) Assignee: CONOPCO, INC., D/B/A UNILEVER, Englewood Cliffs, NJ (US)

(21) Appl. No.: 18/265,849

(22) PCT Filed: Nov. 24, 2021
(86) PCT No.: PCT/EP2021/082738

§ 371 Date: Jun. 7, 2023

(30) Foreign Application Priority Data
Dec. 14, 2020 (IN) 202021054415
Jan. 25, 2021 (EP) 21153179.3
Apr. 1, 2021 (IN) 202121015725

(51) Int. Cl. C11D 1/83; C11D 3/30; C11D 11/00; C11D 17/04

(52) U.S. Cl. CPC C11D 1/83; C11D 3/30; C11D 11/0017; C11D 11/0023; C11D 17/043; C11D 1/22

(57) ABSTRACT

Concentrated detergent composition comprising less than 5% wt. water, anionic surfactant, and a non-aqueous solvent, wherein the anionic surfactant comprises an anionic surfactant with a monoisopropylamine (MIPA) and/or triisopropanolamine (TIPA) counterion, said composition comprising linear alkylbenzene sulphonate.

The present invention relates to a highly concentrated liquid laundry or liquid dishwash composition.

Concentrated fabric treatment compositions comprise surfactants to deliver the appropriate cleaning benefit. They may also preferably comprise cleaning aids such as sequestrants and/or enzymes as well as cleaning polymers such as polyamines and soil release polymers. Similarly, there is a need for more and more concentrated compositions, particularly in a unit dose format such as a water-soluble capsule which ordinarily contains about 15 to 25 ml but there is a strong desire to have smaller doses for such products.

We have surprisingly found that reducing the dose of the composition provides new formulation difficulties, in particular around how to deliver the same cleaning performance from a smaller dose.

Despite the prior art there remains a need for more concentrated laundry and dishwash detergent compositions.

Accordingly, and in a first aspect, there is provided a concentrated detergent composition comprising less than 5% wt. water, anionic surfactant, and a non-aqueous solvent, wherein the anionic surfactant comprises an anionic surfactant with a monoisopropylamine (MIPA) and/or triisopropanolamine (TIPA) counterion, said composition comprising linear alkylbenzene sulphonate.

We have surprisingly found that a MIPA and/or TIPA counterion for the anionic surfactant provides improved products when low water levels are used.

Preferably, the anionic surfactant with a monoisopropylamine (MIPA) and/or triisopropanolamine (TIPA) counterion comprises from 50 to 100% wt. of the anionic surfactant, more preferably from 75% to 100% and more preferably from 90 to 100% wt. of the anionic surfactant.

Preferably, the anionic surfactant with a MIPA counterion is a C10-18 alkyl ether sulphate. Most preferably, it is a C12 based alkyl ether sulphate. The most preferred is MIPA LES, a C12 alkyl ether sulphate with MIPA counterion.

Weight proportions are calculated for the protonated form of the appropriate surfactant. Preferably, the composition is visually clear. By visually clear means that the composition when diluted 1 part premix in 3 parts water is less than 20 NTU.

The composition comprises anionic surfactant and non-ionic surfactant, a proportion of which is preferably a secondary alcohol ethoxylate.

The term “surfactant” in the context of particulate detergent formulations denotes a surfactant which provides a detersive (i.e. cleaning) effect to dishwash compositions or laundry compositions which are used as part of a domestic laundering process.

The composition comprises a non-ionic surfactant. Preferably, fort a dishwashing composition, the composition comprises from 10 to 80% wt. non-ionic surfactant based on the total weight of composition, more preferably from 30 to 60% wt. non-ionic surfactant by weight of the composition.

For laundry composition it is preferred that the non-ionic surfactant is present at from 5 to 45% wt. of the composition.

Secondary Alcohol Ethoxylate

Preferably, the non-ionic surfactant comprises a secondary alcohol ethoxylate. The secondary alcohol ethoxylate comprises an alkyl chain with a secondary ethoxylate joined thereto. The secondary ethoxylate comprises from 2 to 20 EO groups, preferably from 5 to 12 and most preferably 9 EO groups.

The alkyl chain preferably comprises from 8 to 22 carbons, more preferably from 10 to 14 and most preferably 12.

The alkyl chain is preferably saturated.

Preferably, the secondary alcohol ethoxylate is according to the following formula (I):

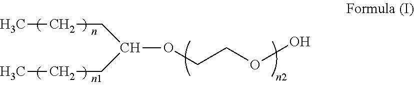

Wherein for Tergitol 15-S-5 n+n1=12 and n2=4; for Tergitol 15-S-7 n+n1=12 and n2=6; and for Tergitol 15-S-9 n+n1=12 and n2=8.

15 A preferred secondary alcohol ethoxylate is Tergitol 15-S 9 ex Dow.

Preferably, the secondary alcohol ethoxylate is present at from 10 to 100% wt. of the total non-ionic surfactant, more preferably from 12% by wt. of the total non-ionic surfactant.

This equates with from about 5% wt. of the total composition to about 60% wt. of the total composition.

We have surprisingly found that the minimum level of secondary alcohol surfactant is preferred to provide a stable and clear product is that described above.

Other Non-Ionics

Other non-ionics the polyoxyalkylene compounds which have a variety of block and heteric (random) structures. For example, they can comprise a single block of alkylene oxide, or they can be diblock alkoxylates or triblock alkoxylates. Within the block structures, the blocks can be all ethylene oxide or all propylene oxide, or the blocks can contain a heteric mixture of alkylene oxides. Examples of such materials include C₈ to C₂₂ alkyl phenol ethoxylates with an average of from 5 to 25 moles of ethylene oxide per mole of alkyl phenol; and aliphatic alcohol ethoxylates such as C₈ to C₁₈ primary or secondary linear or branched alcohol ethoxylates with an average of from 2 to 40 moles of ethylene oxide per mole of alcohol.

A preferred class of nonionic surfactant (additional to the secondary alcohol ethoxylate) for use in the invention includes aliphatic C₁₂ to C₁₅ primary linear alcohol ethoxylates with an average of from 3 to 20, more preferably from 5 to 10 moles of ethylene oxide per mole of alcohol. The alcohol ethoxylate may be provided in a single raw material component or by way of a mixture of components.

Preferably, the LAS is present at from 10 to 50% wt. of the composition for laundry compositions.

A further class of non-ionic surfactants include the alkyl poly glycosides.

Anionic Surfactants

The composition comprises an anionic surfactant. Non-soap anionic surfactants for use in the invention are typically salts of organic sulfates and sulfonates having alkyl radicals containing from about 8 to about 22 carbon atoms, the term “alkyl” being used to include the alkyl portion of higher acyl radicals. Examples of such materials include alkyl sulfates, C12-C14 alkyl ether sulfates, alkaryl sulfonates, alpha-olefin sulfonates and mixtures thereof. The alkyl radicals preferably contain from 10 to 18 carbon atoms and may be unsaturated. The C12-C14 alkyl ether sulfates may contain from one to ten ethylene oxide or propylene oxide units per molecule, and preferably contain one to three ethylene oxide units per molecule.

Commonly used in laundry liquid compositions are C12-C14 alkyl ether sulfates having a straight or branched chain alkyl group having 12 to 14 carbon atoms and containing an average of 1 to 3EO units per molecule. A preferred example is sodium lauryl ether sulfate (SLES) in which the predominantly C12 lauryl alkyl group has been ethoxylated with an average of 3EO units per molecule.

The C12-C14 alkyl ether sulphate may be provided in a single raw material component or by way of a mixture of components.

The counterion for any of the anionic surfactants used in the compositions described herein is principally a monoisopropylamine (MIPA) and/or TIPA, but others are additionally available, for example, alkali metals such as sodium or potassium; or an ammoniacal counterion such as ammonium, monoethanolamine, (MEA), diethanolamine (DEA) or triethanolamine (TEA). Mixtures of such counterions may also be employed.

The compositions according to the invention may preferably include alkylbenzene sulfonates, particularly linear alkylbenzene sulfonates (LAS) with an alkyl chain length of from 10 to 18 carbon atoms. Commercial LAS is a mixture of closely related isomers and homologues alkyl chain homologues, each containing an aromatic ring sulfonated at the “para” position and attached to a 5 linear alkyl chain at any position except the terminal carbons. The linear alkyl chain typically has a chain length of from 11 to 15 carbon atoms, with the predominant materials having a chain length of about C12. Each alkyl chain homologue consists of a mixture of all the possible sulfophenyl isomers except for the 1-phenyl isomer. LAS is normally formulated into compositions in acid (i.e. HLAS) form and then at least partially neutralized in-situ.

Some alkyl sulfate surfactant (PAS) may be used, such as non-ethoxylated primary and secondary alkyl sulphates with an alkyl chain length of from 10 to 18.

The composition comprises an anionic surfactant. Preferably the composition comprises from 10 to 80% wt. anionic surfactant based on the total weight of composition, more preferably from 30 to 60% wt. anionic surfactant by weight of the composition.

Fatty Amides

Where the composition is a dishwash composition it preferably comprises a fatty amide. Suitable fatty amides include cocoamidopropyl betaine (CAPB), coco amido propyl amine oxide (CAPAO), cocodiethanol amide (ODEA) and cocomonoethanol amide (CMEA). Most preferred amphoteric surfactant is cocoamidopropyl betaine.

Preferably, the fatty amide is present at from 0.1 to 10% wt. of the composition.

Fatty Acids

Where the composition is a laundry composition it is preferred that it comprises a fatty acid.

Suitable fatty acids for laundry liquid compositions in the context of this invention include aliphatic carboxylic acids of formula RCOOH, where R is a linear or branched alkyl or alkenyl chain containing from 6 to 24, more preferably 10 to 22, most preferably from 12 to 18 carbon atoms and 0 or 1 double bond. Preferred examples of such materials include saturated C12-18 fatty acids such as lauric acid, myristic acid, palmitic acid or stearic acid; and fatty acid mixtures in which 50 to 100% (by weight based on the total weight of the mixture) consists of saturated C12-18 fatty acids. Such mixtures may typically be derived from natural fats and/or optionally hydrogenated natural oils (such as coconut oil, palm kernel oil or tallow).

The fatty acids may be present in the form of their sodium, potassium or ammonium salts and/or in the form of soluble salts of organic bases, such as mono-, di- or triethanolamine.

Mixtures of any of the above described materials may also be used.

Fatty acids and/or their salts, when included, may be present in an amount ranging from about 0.25 to 5%, more preferably from 0.5 to 5%, most preferably from 0.75 to 4% (by weight based on the total weight of the composition).

For formula accounting purposes, in the formulation, fatty acids and/or their salts (as defined above) are not included in the level of surfactant or in the level of builder.

Non-Aqueous Solvents

Preferably, the composition comprises a non-aqueous solvent.

Suitable non-aqueous solvents include:
glycol ethers (e.g. diethylene glycol alkyl ether (esp. diethylene butyl ether), dipropylene glycol alkyl ether, especially dipropylene dimethyl ether));
alkyl esters (e.g. alkyl levulinate, preferably where alkyl is C1-C4 and most preferably where alkyl is ethyl; alkyl octanoate, preferably where alkyl is C1-C4 and most preferably where alkyl is methyl and alkyl soyate, preferably where alkyl is C1-C4 and most preferably where alkyl is methyl). The most preferred alkyl esters are ethyl levulinate, methyl soyate and methyl octanoate.
C1-4 alkyl amides, e.g. N,N-dimethyl alkenamide, more preferably N,N-dimethyl decenamide.
alkyl alkoxylate, e.g. benzyl alkoxylate.

Preferred non-aqueous solvents include those with a Hansen Solubility Parameter D between 12 and 20; a P value between 2.3 and 12 and a H value between 5 and 25.

Preferably, the non-aqueous solvent is present at from 1 to 20% wt. of the composition, more preferably from 1.5 to 15% wt. and most preferably from 2 to 10% wt. of the composition.

Hydrotrope

A composition of the invention may incorporate non-aqueous carriers such as hydrotropes, co-solvents and phase stabilizers. Such materials are typically low molecular weight, water-soluble or water-miscible organic liquids such as C1 to C5 monohydric alcohols (such as ethanol and n- or i-propanol); C2 to C6 diols (such as monopropylene glycol and dipropylene glycol); C3 to C9 triols (such as glycerol); polyethylene glycols having a weight average molecular weight (M_{w}) ranging from about 200 to 600; C1 to C3 alkanolamines such as mono-, di- and triethanolamines; and alkyl aryl sulfonates having up to 3 carbon atoms in the lower alkyl group (such as the sodium and potassium xylene, toluene, ethylbenzene and isopropyl benzene (cumene) sulfonates).

Mixtures of any of the above described materials may also be used.

Non-aqueous carriers, when included, may be present in an amount ranging from 0.1 to 20%, preferably from 2 to 15%, and more preferably from 10 to 14% (by weight based on the total weight of the composition). The level of hydrotrope used is linked to the level of surfactant and it is desirable to use hydrotrope level to manage the viscosity in such compositions. The preferred hydrotropes are monopropylene glycol and glycerol.

Enzymes

A composition of the invention preferably comprises an effective amount of one or more enzyme preferably selected from the group comprising, hemicellulases, peroxidases, proteases, cellulases, hemicellulases, xylanases, xantanase, lipases, phospholipases, esterases, cutinases, pectinases, carrageenases, mannanases, pectate lyases, keratinases, reductases, oxidases, phenoloxidases, lipoxygenases, ligninases, pullulanases, tannases, pentosanases, malanases, β-glucanases, arabinosidases, hyaluronidase, chondroitinase, laccase, tannases, amylases, nucleases (such as deoxyribonuclease and/or ribonuclease), phosphodiesterases, or mixtures thereof. Particularly preferred are mixtures of protease, amylase, lipase, cellulase, phosphodiesterase, and/or pectate lyase.

Preferably the level of an enzyme is from 0.1 to 600, more preferably form 0.5 to 450, most preferably from 1 to 400 mg active enzyme protein per 100g finished product.

Preferably the protease enzyme is present in the greatest weight fraction. Preferably the protease is present a levels that are greater than 3 times any other single enzyme.

Examples of preferred enzymes are sold under the following trade names Purafect Prime®, Purafect®, Preferenz® (DuPont), Savinase®, Pectawash®, Mannaway®, Lipex®, Lipoclean®, Whitzyme® Stainzyme®, Stainzyme Plus®, Natalase®, Mannaway®, Amplify® Xpect®, Celluclean® (Novozymes), Biotouch (AB Enzymes), Lavergy® (BASF).

Detergent enzymes are discussed in WO2020/186028(Procter and Gamble), WO2020/200600 (Henkel), WO2020/070249 (Novozymes), WO2021/001244 (BASF) and WO2020/259949 (Unilever).

A nuclease enzyme is an enzyme capable of cleaving the phosphodiester bonds between the nucleotide sub-units of nucleic acids and is preferably a deoxyribonuclease or ribonuclease enzyme. Preferably the nuclease enzyme is a deoxyribonuclease, preferably selected from any of the classes E.C. 3.1.21.x, where x=l, 2, 3, 4, 5, 6, 7, 8 or 9, E.C. 3.1.22.y where y=l, 2, 4 or 5, E.C. 3.1.30.Z where z=1 or 2, E.C. 3.1.31.1 and mixtures thereof.

Builders and Sequestrants

The compositions preferably contains organic detergent builder or sequestrant material. Examples include the alkali metal, citrates, succinates, malonates, carboxymethyl succinates, carboxylates, polycarboxylates and polyacetyl carboxylates. Specific examples include sodium, potassium and lithium salts of oxydisuccinic acid, mellitic acid, benzene polycarboxylic acids, and citric acid. Other examples are DEQUEST™, organic phosphonate type sequestering agents sold by Monsanto and alkanehydroxy phosphonates.

Other suitable organic builders include the higher molecular weight polymers and copolymers known to have builder properties. For example, such materials include appropriate polyacrylic acid, polymaleic acid, and polyacrylidpolymaleic acid copolymers and their salts, for example those sold by BASF under the name SOKALAN™. If utilized, the organic builder materials may comprise from about 0.5 percent to 20 wt percent, preferably from 1 wt percent to 10 wt percent, of the composition. The preferred builder level is less than 10 wt percent and preferably less than 5 wt percent of the composition. More preferably the liquid laundry detergent formulation is a non-phosphate built laundry detergent formulation, i.e., contains less than 1 wt. % of phosphate. Most preferably the laundry detergent formulation is not built i.e. contain less than 1 wt. % of builder. A preferred sequestrant is HEDP (1-Hydroxyethylidene-1,1,-diphosphonic acid), for example sold as Dequest 2010. Also suitable but less preferred as it gives inferior cleaning results is Dequest(R) 2066 (Diethylenetriamine penta(methylene phosphonic acid or Heptasodium DTPMP).

Water

Preferably, the composition comprises less than 5% water. By free water is meant water which is added to the composition and does not include water which is added along with a further raw material in which it is incorporated. For example, many surfactants are commercially available as aqueous solutions or suspensions of surfactants.

Most preferably, the composition comprises less than 1% wt. water.

Water-Soluble Film Compositions

Where the composition is a unit dose composition it is preferably contained within a pouch formed by a water dissoluble film.

Such water-soluble film compositions, optional ingredients for use therein, and methods of making the same are well known in the art, whether being used for making relatively thin water-soluble films (e.g., as pouch materials) or otherwise.

In one class of embodiments, the water-soluble film includes a water dissoluble material. Preferred such materials include polyvinyl alcohol (PVOH), including homopolymers thereof (e.g., including substantially only vinyl alcohol and vinyl acetate monomer units) and copolymers thereof (e.g., including one or more other monomer units in addition to vinyl alcohol and vinyl acetate units). PVOH is a synthetic resin generally prepared by the alcoholysis, usually termed hydrolysis or saponification, of polyvinyl acetate. Fully hydrolyzed PVOH, wherein virtually all the acetate groups have been converted to alcohol groups, is a strongly hydrogen-bonded, highly crystalline polymer which dissolves only in hot water—greater than about 140 degrees Fahrenheit (60 degrees C.). If a sufficient number of acetate groups are allowed to remain after the hydrolysis of polyvinyl acetate, the PVOH polymer then being known as partially hydrolyzed, it is more weakly hydrogen-bonded and less crystalline and is soluble in cold water—less than about 50 degrees Fahrenheit (10 degrees C.). An intermediate cold or hot water soluble film can include, for example, intermediate partially-hydrolyzed PVOH (e.g., with degrees of hydrolysis of about 94 percent to about 98 percent), and is readily soluble only in warm water—e.g., rapid dissolution at temperatures of about 40 degrees centigrade and greater. Both fully and partially hydrolyzed PVOH types are commonly referred to as PVOH homopolymers although the partially hydrolyzed type is technically a vinyl alcohol-vinyl acetate copolymer.

The degree of hydrolysis (DH) of the PVOH polymers and PVOH copolymers included in the water-soluble films of the present disclosure can be in a range of about 75 percent to about 99 percent (e.g., about 79 percent to about 92 percent, about 86.5 percent to about 89 percent, or about 88 percent, such as for cold-water soluble compositions; about 90 percent to about 99 percent, about 92 percent to about 99 percent, or about 95 percent to about 99 percent). As the degree of hydrolysis is reduced, a film made from the resin will have reduced mechanical strength but faster solubility at temperatures below about 20 degrees centigrade As the degree of hydrolysis increases, a film made from the polymer will tend to be mechanically stronger and the thermoformability will tend to decrease. The degree of hydrolysis of the PVOH can be chosen such that the water-solubility of the polymer is temperature dependent, and thus the solubility of a film made from the polymer, any compatibilizer polymer, and additional ingredients is also influenced. In one option the film is cold water-soluble. A cold water-soluble film, soluble in water at a temperature of less than 10 degrees centigrade, can include PVOH with a degree of hydrolysis in a range of about 75 percent to about 90 percent, or in a range of about 80 percent to about 90 percent, or in a range of about 85 percent to about 90 percent. In another option the film is hot water-soluble. A hot water-soluble film, soluble in water at a temperature of at least about 60 degrees centigrade, can include PVOH with a degree of hydrolysis of at least about 98 percent.

Other water soluble polymers for use in addition to the PVOH polymers and PVOH copolymers in the blend can include, but are not limited to modified polyvinyl alcohols, polyacrylates, water-soluble acrylate copolymers, polyvinyl pyrrolidone, polyethyleneimine, pullulan, water-soluble natural polymers including, but not limited to, guar gum, gum Acacia, xanthan gum, carrageenan, and starch, water-soluble polymer derivatives including, but not limited to, modified starches, ethoxylated starch, and hydroxypropylated starch, copolymers of the forgoing and combinations of any of the foregoing. Yet other water-soluble polymers can include polyalkylene oxides, polyacrylamides, polyacrylic acids and salts thereof, celluloses, cellulose ethers, cellulose esters, cellulose amides, polyvinyl acetates, polycarboxylic acids and salts thereof, polyaminoacids, polyamides, gelatines, methylcelluloses, carboxymethylcelluloses and salts thereof, dextrins, ethylcelluloses, hydroxyethyl celluloses, hydroxypropyl methylcelluloses, maltodextrins, and polymethacrylates. Such water-soluble polymers, whether PVOH or otherwise are commercially available from a variety of sources. Any of the foregoing water-soluble polymers are generally suitable for use as film-forming polymers. In general, the water-soluble film can include copolymers and/or blends of the foregoing resins.

The water-soluble polymers (e.g., the PVOH resin blend alone or in combination with other water-soluble polymers) can be included in the film in an amount in a range of about 30 weight percent or 50 weight percent to about 90 weight percent or 95 weight percent, for example. The weight ratio of the amount of all water-soluble polymers as compared to the combined amount of all plasticizers, compatibilizing agents, and secondary additives can be in a range of about 0.5 to about 18, about 0.5 to about 15, about 0.5 to about 9, about 0.5 to about 5, about 1 to 3, or about 1 to 2, for example. The specific amounts of plasticizers and other non-polymer component can be selected in a particular embodiment based on an intended application of the water-soluble film to adjust film flexibility and to impart processing benefits in view of desired mechanical film properties.

Water-soluble polymers for use in the film described herein (including, but not limited to PVOH polymers and PVOH copolymers) can be characterized by a viscosity in a range of about 3.0 to about 27.0 cP, about 4.0 to about 24.0 cP, about 4.0 to about 23.0 cP, about 4.0 cP to about 15 cP, or about 6.0 to about 10.0 cP, for example. The viscosity of a polymer is determined by measuring a freshly made solution using a Brookfield LV type viscometer with UL adapter as described in British Standard EN ISO 15023-2:2006 Annex E Brookfield Test method. It is international practice to state the viscosity of 4 percent aqueous polyvinyl alcohol solutions at 20 degrees centigrade Polymeric viscosities specified herein in cP should be understood to refer to the viscosity of a 4 percent aqueous water-soluble polymer solution at 20 degrees centigrade, unless specified otherwise.

It is well known in the art that the viscosity of a water-soluble polymer (PVOH or otherwise) is correlated with the weight-average molecular weight (W) of the same polymer, and often the viscosity is used as a proxy for Mw. Thus, the weight-average molecular weight of the water-soluble polymers, including the first PVOH copolymer and second PVOH polymer, can be in a range of about 30,000 to about 175,000, or about 30,000 to about 100,000, or about 55,000 to about 80,000, for example.

The water-soluble film can contain other auxiliary agents and processing agents, such as, but not limited to, plasticizers, plasticizer compatibilizers, surfactants, lubricants, release agents, fillers, extenders, cross-linking agents, antiblocking agents, antioxidants, detackifying agents, antifoams, nanoparticles such as layered silicate-type nanoclays (e.g., sodium montmorillonite), bleaching agents (e.g., sodium metabisulfite, sodium bisulfite or others), aversive agents such as bitterants (e.g., denatonium salts such as denatonium benzoate, denatonium saccharide, and denatonium chloride; sucrose octaacetate; quinine; flavonoids such as quercetin and naringen; and quassinoids such as quassin and brucine) and pungents (e.g., capsaicin, piperine, allyl isothiocyanate, and resinferatoxin), and other functional ingredients, in amounts suitable for their intended purposes. Embodiments including plasticizers are preferred. The amount of such agents can be up to about 50 wt., 20 wt percent, 15 wt percent, 10 wt percent, 5 weight percent, 4 wt percent and/or at least 0.01 weight percent, 0.1 wt percent, 1 wt percent, or 5 wt, individually or collectively.

The plasticizer can include, but is not limited to, glycerin, diglycerin, sorbitol, ethylene glycol, diethylene glycol, triethylene glycol, dipropylene glycol, tetraethylene glycol, propylene glycol, polyethylene glycols up to 400 MW, neopentyl glycol, trimethylolpropane, polyether polyols, sorbitol, 2-methyl-1,3-propanediol, ethanolamines, and a mixture thereof. A preferred plasticizer is glycerin, sorbitol, triethyleneglycol, propylene glycol, diproyplene glycol, 2-methyl-1,3-propanediol, trimethylolpropane, or a combination thereof. The total amount of the plasticizer can be in a range of about 10 weight percent to about 40 wt., or about 15 weight percent to about 35 wt., or about 20 weight percent to about 30 wt., for example about 25 wt., based on total film weight. Combinations of glycerin, dipropylene glycol, and sorbitol can be used. Optionally, glycerin can be used in an amount of about 5 wt percent to about 30 wt, or 5 wt percent to about 20 wt, e.g., about 13 wt percent.

Optionally, dipropylene glycol can be used in an amount of about 1 weight percent to about 20 wt., or about 3 weight percent to about 10 wt., for example 6 weight percent. Optionally, sorbitol can be used in an amount of about 1 wt percent to about 20 wt, or about 2 wt percent to about 10 wt, e.g., about 5 wt percent. The specific amounts of plasticizers can be selected in a particular embodiment based on desired film flexibility and processability features of the water-soluble film. At low plasticizer levels, films may become brittle, difficult to process, or prone to breaking. At elevated plasticizer levels, films may be too soft, weak, or difficult to process for a desired use.

In a preferred embodiment the composition comprises a taste aversive such as denatonium benzoate and/or a pungent agent such as capsaicin.

Preferably the composition is a unit dosed composition of from 4 to 12 ml and contained within a water dissoluble pouch as described above.

Optional Components

A composition may also contain one or more cosurfactants (such as amphoteric (zwitterionic) and/or cationic surfactants) in addition to the non-soap anionic and/or non-ionic detersive surfactants described above.

Specific cationic surfactants include C₈ to C₁₈ alkyl dimethyl ammonium halides and derivatives thereof in which one or two hydroxyethyl groups replace one or two of the methyl groups, and mixtures thereof. Cationic surfactant, when included, may be present in an amount ranging from 0.1 to 5% (by weight based on the total weight of the premix composition).

Specific amphoteric (zwitterionic) surfactants include alkyl amine oxides, alkyl betaines, alkyl amidopropyl betaines, alkyl sulphobetaines (sultaines), alkyl glycinates, alkyl carboxyglycinates, alkyl amphoacetates, alkyl amphopropionates, alkylamphoglycinates, alkyl amidopropyl hydroxysultaines, acyl taurates and acyl glutamates, having alkyl radicals containing from about 8 to about 22 carbon atoms, the term “alkyl” being used to include the alkyl portion of higher acyl radicals. Amphoteric (zwitterionic) surfactant, when included, may be present in an amount ranging from 0.1 to 5% (by weight based on the total weight of the composition).

A composition may also contain one or more chelating agents for transition metal ions. Such chelating agents may also have calcium and magnesium chelation capacity, but preferentially bind heavy metal ions such as iron, manganese and copper. Such chelating agents may help to improve the stability of the composition and protect for example against transition metal catalyzed decomposition of certain ingredients.

Suitable transition metal ion chelating agents include phosphonates, in acid and/or salt form. When utilized in salt form, alkali metal (e.g. sodium and potassium) or alkanolammonium salts are preferred. Specific examples of such materials include aminotris(methylene phosphonic acid) (ATMP), 1-hydroxyethylidene diphosphonic acid (HEDP) and diethylenetriamine penta(methylene phosphonic acid (DTPMP) and their respective sodium or potassium salts. HEDP is preferred. Mixtures of any of the above described materials may also be used.

Transition metal ion chelating agents, when included, may be present in an amount ranging from about 0.1 to about 10%, preferably from about 0.1 to about 3% (by weight based on the total weight of the composition). Mixtures of any of the above described materials may also be used.

A composition may also comprise an effective amount of one or more enzyme selected from the group comprising, pectate lyase, protease, amylase, cellulase, lipase, mannanase and mixtures thereof. The enzymes are preferably present with corresponding enzyme stabilizers.

A composition may contain further optional ingredients to enhance performance and/or consumer acceptability. Examples of such ingredients include foam control agents, preservatives (e.g. bactericides), fluorescers and pearlisers. Each of these ingredients will be present in an amount effective to accomplish its purpose. Generally, these optional ingredients are included individually at an amount of up to 5% (by weight based on the total weight of the composition).

Packaging and Dosing

A composition of the invention may be packaged as unit dose in polymeric film soluble in the wash water. Alternatively, a composition of the invention may be supplied in multidose plastics packs with a top or bottom closure. A dosing measure may be supplied with the pack either as a part of the cap or as an integrated system.

In a second aspect there is provided a method for forming a dishwash or laundry liquid composition by taking a composition as described herein and adding from 3 to 100 parts of water to one part of composition and mixing. The resulting laundry or dishwash liquid composition is stable and may be kept by the consumer until ready for use as a liquid detergent composition.

In a third aspect there is provided a packaged product comprising a composition as described herein.

In a fourth aspect there is provided a method for forming a laundry or dishwash liquid composition by taking a composition as described herein and adding from 3 to 100 parts of water to one part of composition and mixing. The resulting laundry or dishwash liquid composition is stable and may be kept by the consumer until ready for use as a liquid detergent composition.

### EXAMPLES

### Example 1

The following are formulations according to embodiments of the invention.

TABLE 1

| | Example 1 | Example 2 | Example 3 |
|---|---|---|---|
| Ingredients | As is % | As is % | As is % |
| LAS acid | 36.5 | 24.9 | 24.9 |
| MEA | 7.3 | 5.1 | 5.1 |
| Tergitol 15-S-7 | 0 | 12.5 | 36 |
| Nonionic -EO7 | 25 | 26 | 0 |
| Genapol BA 040 | 5 | 5 | 5 |
| Fragrance | 1.5 | 1.5 | 1.5 |
| MIPA-LES | 24.7 | 25 | 25 |
| MPG | 0 | 0 | 2.5 |
| | 100 | 100 | 100 |

The following is a process for making such formulations.

Process:
1. LAS acid neutralization by mono-ethanolamine
2. Mix the Nonionic EO7/Tergitol 15-S-7 to the LAS-MEA paste at 60° C.
3. Add genapol, fatty amide followed by perfume

The following is an ultraconcentrated laundry compositions according to embodiments of the invention.

### Example 2

TABLE 2

| | A | 1 |
|---|---|---|
| Ingredient | wt % | Wt % |
| LAS Acid | 35.417 | 31.250 |
| MEA | 7.320 | 6.250 |
| NI 7EO | 34.000 | 30.000 |
| Fatty Acid | 5.000 | 0.000 |
| MIPA-LES | 0.000 | 0.000 |
| MPG | 10.000 | 5.030 |
| Dequest 2066 | 6.250 | 6.250 |
| Silicon Antifoam emulsion | 0.000 | 0.000 |
| Perfume | 2.000 | 0.900 |
| Enzyme | 0.000 | 0.000 |
| BPP Solvent | 0.000 | 20.000 |
| Total | 100.00 | 100.000 |

Foam volume was measured using Bartsch test method with 1.25 g concentration in 15 FH water.

| | Foam volume (ml) | STDEV |
|---|---|---|
| MIPA-LES | 130 | 1 |
| MEA-LAS + MIPA-LES (60:40) | 150 | 1 |

The foam volume experiment shows that using MIPA LES and MEA LAS we achieved a higher level of foam than for MIPA LES alone. The total level of surfactant was the same in each case.

### Plate Yield Measurements

Plate yield

| | EO7 | MIPA-LES |
|---|---|---|
| MEA-LAS | 34.6 | 41.4 |

The plate yield experiment shows that the plate yield is higher for MIPA LES and MEA LAS than for non-ionic alone with MEA LAS.

1. Concentrated detergent composition comprising less than 5% wt. water, anionic surfactant, and a non-aqueous solvent, wherein the anionic surfactant comprises an anionic surfactant with a monoisopropylamine (MIPA) and/or triisopropanolamine (TIPA) counterion, said composition comprising linear alkylbenzene sulphonate.

2. Composition according to claim 1 wherein said anionic surfactant with a monoisopropylamine (MIPA) and/or triisopropanolamine (TIPA) counterion comprises from 50 to 100% wt. of the anionic surfactant.

3. Composition according to claim 1 wherein the non-ionic surfactant comprises a secondary alcohol ethoxylate.

4. Composition according to claim 3 wherein the secondary alcohol ethoxylate comprises up to 100% wt. of the total non-ionic surfactant in the composition.

5. Composition according to claim 1 wherein the anionic surfactant and the non-ionic surfactant comprise from 70 to 95% wt. of the composition.

6. Composition according to claim 1 wherein the weight ratio between the anionic and the non-ionic surfactant is from 1.3:1 to 1:1.3.

7. Composition according to claim 1 wherein the secondary alcohol ethoxylate comprises from 2 to 20 EO groups.

8. Composition according to claim 1 wherein the secondary alcohol ethoxylate comprises from C10 to C20 secondary alkyl.

9. Composition according to claim 1 in a unit dose format.

10. Composition according to claim 9 wherein a unit dose of composition is disposed in a water dissoluble pouch.

11. A method for forming a liquid dishwash detergent composition by dispersing a dose of a composition according to claim 1 in water.

12. A method of forming a dishwash liquor by dispersing a dose of a composition according to claim 1 in water.

13. A method for forming a liquid laundry detergent composition by dispersing a dose of a composition according to claim 1 in water.

14. A method of forming a laundry liquor by dispersing a dose of a composition according to claim 1 in water.
